(19) United States
(12) Patent Application Publication
(10) Pub. No.: US 2012/0177778 A1
(43) Pub. Date: Jul. 12, 2012

(54) SCENTED BIRDSEED AS A SQUIRREL DETERRENT

(75) Inventor: Mario Olmos, Fort Worth, TX (US)

(73) Assignee: CENTRAL GARDEN & PET COMPANY, Walnut Creek, CA (US)

(21) Appl. No.: 13/348,471

(22) Filed: Jan. 11, 2012

Related U.S. Application Data
(60) Provisional application No. 61/431,750, filed on Jan. 11, 2011.

(51) Int. Cl. A23K 1/18

(52) U.S. Cl. 426/1

(57) ABSTRACT

The present disclosure generally provides a scented compound applied to animal feed, particularly birdseed, in order to deter squirrels from consuming the feed. This scented compound may deter squirrels in that squirrels often quickly detect most aromatic compounds due to squirrels' keen olfactory sense, while birds may not notice them at all. Further, given that this scented compound is non-toxic to both birds and squirrels, birds may consume the scented birdseed and birds and squirrels can smell the scented compound without experiencing health issues. The scented compound applied to birdseed may be citrus or peppermint oil.

### CROSS-REFERENCE TO RELATED APPLICATIONS

This application claims the benefit of Provisional Application No. 61,431,750, filed on Jan. 11, 2011, entitled “Citrus-Scented Birdseed as a Squirrel Deterrent” and is incorporated by reference herein in its entirety.

### FIELD OF THE INVENTION

The disclosure relates generally to animal feed and in particular to use of scented birdseed as a squirrel deterrent.

### BACKGROUND

Many consumers who maintain backyard bird feeders experience frustration when their attempt to feed birds with conventional birdseed mixes is hampered by squirrels. Squirrels tend to gravitate toward conventional birdseed mixes and tend to deplete the supply of birdseed, thereby adversely affecting the birds' ability to feed on the birdseed.

In the past, bird feeders have been developed and marketed as being impenetrable to squirrels. However, as is often the case, squirrels find a way to access the birdseed contained in these feeders, again preventing the birds from obtaining the birdseed meant for them before the squirrels deplete the supply.

### SUMMARY

Embodiments of the present disclosure generally provide for use of scented birdseed as a squirrel deterrent. According to an embodiment of the present disclosure, a scented compound, such as citrus or peppermint oil, may be applied to animal feed, particularly birdseed in the form of loose birdseed or seed cakes, in order to deter squirrels from consuming the feed.

A scented seed cake prepared according to an embodiment of the present disclosure may include water (approximately 56%-66% of the seed cake by weight), corn sugar dextrose (approximately 10%-20% of the seed cake by weight), oil honey (approximately 2%-12% of the seed cake by weight), gelatin (approximately 16% to 26% of the seed cake by weight), glycerine (approximately 5% to 15% of the seed cake by weight), propionac liquid/acid (approximately 5% to 15% of the seed cake by weight) and citrus or peppermint oil (approximately 1% to 8% of the seed cake by weight). Any combination of seeds may be included in scented seed cakes or loose birdseed mixtures according to embodiments of the present disclosure.

In an embodiment of the present disclosure, scented seed cakes may be prepared by heating water to approximately 150° F. Corn sugar dextrose and gelatin may then be added to the heated water followed by oil honey, glycerine, propionac liquid/acid, and citrus or peppermint oil. The ingredients may be combined and mixed until dispersed.

### BRIEF DESCRIPTION OF THE DRAWINGS

For a more complete understanding of this disclosure and its features, reference is now made to the following description, taken in conjunction with the accompanying drawings, in which:

FIG. 1 depicts squirrel and bird activity at scented and control (unscented) seed cakes according to an embodiment of the present disclosure;

FIG. 2 depicts a statistical comparison of squirrel and bird feeding events at scented versus control (unscented) seed cakes according to an embodiment of the present disclosure;

FIG. 3 depicts a statistical comparison of squirrel and bird activity at seed cakes versus loose birdseed according to an embodiment of the present disclosure;

FIG. 4 depicts squirrel and bird activity at seed cakes versus loose birdseed according to an embodiment of the present disclosure;

FIG. 5 depicts squirrel and bird activity at scented versus control (unscented) loose birdseed according to an embodiment of the present disclosure; and

FIG. 6 depicts a statistical comparison of squirrel and bird activity at scented loose birdseed versus control (unscented) loose birdseed according to an embodiment of the present disclosure.

### DETAILED DESCRIPTION

Embodiments of the present disclosure generally may provide birdseed having properties (i.e., scent) such that it is not as desirable for squirrels, and accordingly, squirrels are unwilling to put considerable effort into acquiring the birdseed. Therefore, birds may be more likely to consume the scented birdseed than squirrels, and the birdseed likely may not require replenishment as frequently as unscented birdseed preferred by squirrels. This improved birdseed may deter squirrels and improve the bird-feeding experience for consumers.

According to an embodiment of the present disclosure, a scented compound, such as citrus or peppermint oil, may be applied to animal feed, particularly birdseed, in order to deter squirrels from consuming the feed. This scented compound may have a deterrent effect in that squirrels often quickly detect most aromatic compounds due to squirrels' keen olfactory sense, while birds may not notice them at all. Further, given that this scented compound is non-toxic to both birds and squirrels, birds may consume the scented birdseed and birds and squirrels may smell the scented compound without experiencing health issues.

The scented compound may be incorporated into seed cakes as will be explained in more detail below. However, it should be appreciated that the scented compound also may be applied to loose birdseed without departing from the present disclosure.

According to an embodiment of the present disclosure, seed cakes may include water (approximately 56%-66% of the seed cake by weight), corn sugar dextrose (approximately 10%-20% of the seed cake by weight), oil honey (approximately 2%-12% of the seed cake by weight), gelatin (approximately 16% to 26% of the seed cake by weight), glycerine (approximately 5% to 15% of the seed cake by weight), propionac liquid/acid (approximately 5% to 15% of the seed cake by weight) and citrus or peppermint oil (approximately 1% to 8% of the seed cake by weight).

It should be appreciated that other seeds may be included in a seed cake without departing from the present disclosure. Further, the composition of seed cakes and/or loose birdseed according to embodiments of the present disclosure may vary depending on the composition of birdseed or seed cake that may be desired. Components including, but not necessarily limited to, cor, cracked corn, striped sunflower seeds, black oil sunflower seeds, safflower seeds, peanuts, peanut hearts, milo, white millet, red millet, nyjer seed or thistle, canary seed, german millet, pepitas (pumpkin kernels), flax seeds, almonds, cherries, and raisins may be incorporated into the seed cake and/or loose birdseed composition without departing from the present disclosure.

Citrus oil coated or included in seed cakes and/or loose birdseed according to embodiments of the present disclosure may be 135a23 natural and artificial citrus flavor provided by Abelei Flavors. Another blend that may be used according to embodiments of the present disclosure may be 135a22 natural and artificial citrus flavor, also offered by Abelei Flavors. This citrus oil generally may take the form of a translucent orange-yellow liquid with the characteristic flavor and aroma of citrus fruits. This citrus oil is insoluble in water and may have a specific gravity in the range of 0.915 to 0.920 with a standard deviation of ±0.02. All materials used in the manufacture of the citrus flavor are in conformance with all applicable FDA, ASTA, and FCC standards. The non-flavor components that may be included in this citrus-scented compound according to embodiments of the present disclosure are soybean oil with TBHQ and citric acid. However, it should be appreciated that other citrus oils may be used without departing from the present disclosure. Further, various peppermint oils may be used according to embodiments of the present disclosure and generally have a menthol concentration above 50%.

In order to prepare seed cakes according to an embodiment of the present disclosure, water may be heated to approximately 150° F. Corn sugar dextrose and gelatin may then be added to water followed by oil honey, glycerine, propionac liquid/acid, and citrus or peppermint oil. The ingredients may be combined in a kettle and mixed with a high-speed paddle mixer until completely dispersed.

In order to evaluate the effectiveness of scented seed cakes and/or loose birdseed according to embodiments of the present disclosure, various trials were conducted.

A first set of trials evaluating the effectiveness of citrus-scented birdseed in deterring squirrels was conducted in the vicinity of Auburn, Ala. as well as in Opalika, Ala. The concentration of citrus-scented compound used in the various phases of the trials was determined qualitatively. A description of the three phases of the trials, and results related to same, follows.

The first phase of the trials examined the relative preference of squirrels and birds for citrus-scented seed cakes relative to unscented control seed cakes.

Control (unscented) seed cakes were prepared by mixing 0.25 kg binding solution with 0.75 kg birdseed. The experimental citrus-scented seed cakes were prepared by mixing 0.085 kg citrus oil and 0.24 kg binding solution with 0.75 kg birdseed. The binding solution used in both the control seed cakes and the experimental seed cakes was comprised of 35% gelatin and 65% water. Both the control seed cakes and the experimental seed cakes utilized in this phase of the trials were prepared using Kaytee Birder's Blend wild birdseed. However, it should be appreciated that seed cakes may include other types of birdseed without departing from the present disclosure.

This first phase of the trials was completed over approximately a one-month period in Spring 2010 at 20 residential properties where residents maintained bird feeders that were regularly visited by squirrels. The residential properties utilized in this phase were separated by at least 0.1 m.

Two seed cakes (one control seed cake and one experimental seed cake) were placed on Sheppard hooks fitted with a board along the vertical post. The board allowed the squirrels to readily climb the hook. The presence of the board also ensured that squirrel access would be consistent between sampling events. The Sheppard hooks were placed 3 feet apart at each residential property, and they were generally placed in a location so as to replace an existing bird feeder.

The placement of each seed cake type (i.e., on which of the two hooks each seed cake was placed) was determined through a coin toss. The seed cakes were hung on the hooks by drilling a hole through the center of each seed cake, and galvanized wire was used to affix the seed cake to the hook.

The two seed cakes were hung at each residential property for a minimum of three days. If squirrel and bird activity was minimal on the residential property, the duration of the acclimation period was extended and/or that particular residential property was no longer used in this phase of the trials.

On the fourth and fifth days of this phase of the trials, a single seed cake was hung at each residential property. On one of these two days, this seed cake was an experimental (citrus-scented) seed cake. On the alternate day, the control (unscented) cake was presented. A coin toss was used to randomly determine which seed cake would be hung at the residential property on the fourth day of the trial. If the weather conditions differed substantially between days, this part of the phase was repeated at the affected residential property (or properties) so that conditions during the observations were comparable.

After a 10-minute acclimation period, the seed cakes were monitored for one hour at a time in each location. Bird and squirrel feeding was quantified based on 60-second instantaneous scan samples.

Eastern Gray squirrels as well as 17 species of birds were observed during scan sampling observations in this first phase of the trials. If a species was observed at four or fewer locations (residential properties) during the scan sampling observations, that species was excluded as it presents a challenge to detect a preference based on fewer than five sampling locations. The following species were excluded: the Red-winged Blackbird, Purple Finch, Common Grackle, Dark-eyed Junco, Brown-headed Nuthatch, Eastern Towhee, Downy Woodpecker, Red-bellied Woodpecker, and Carolina Wren.

Squirrels were observed at all residential properties where scan sampling observations were recorded in this first phase of the trials. However, it should be appreciated that squirrels only visited seed cakes at 5 out of 20 residential properties during these scan sampling observations.

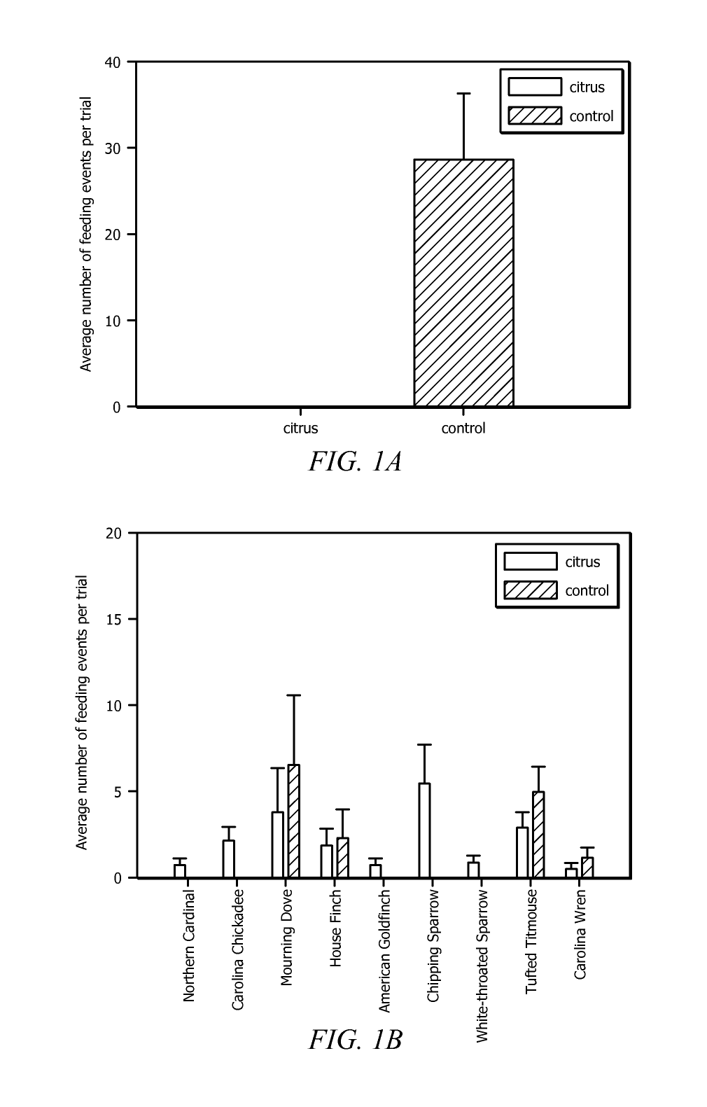

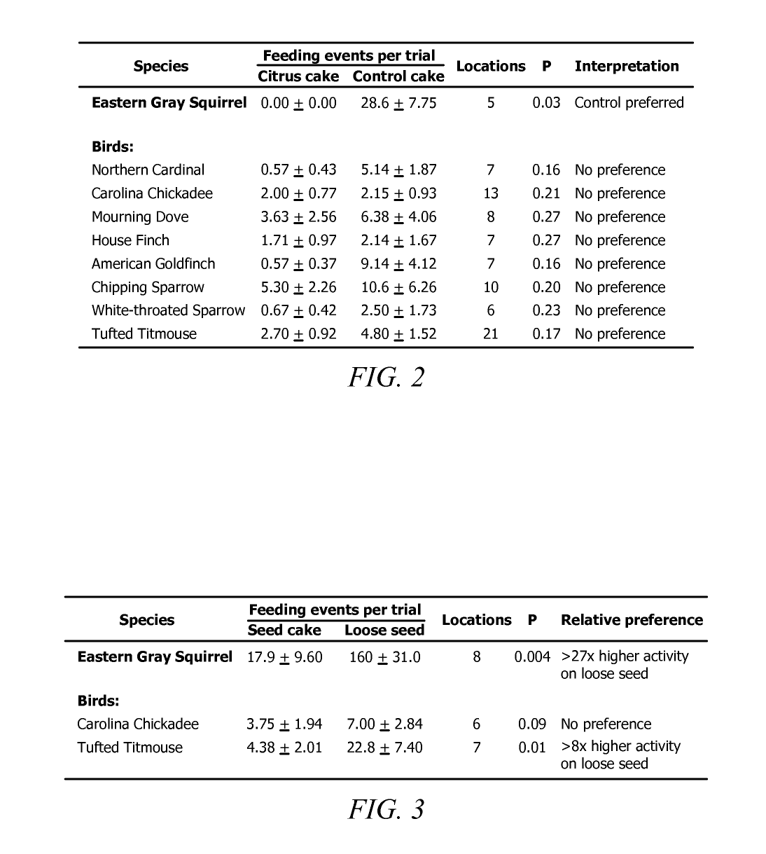

Seed preference was evaluated using a sign test. Squirrels displayed a significant preference for the control (unscented) seed cakes. Squirrels were not observed consuming the experimental (citrus-scented) cakes during scan sampling as reflected in FIGS. 1 and 2. It should be appreciated, however, that during the acclimation period, squirrels were observed consuming, removing, and caching control as well as experimental seed cakes. Accordingly, despite an apparent preference for the control seed cakes, squirrels were not completely deterred by the citrus-scented compound that was part of the experimental seed cakes. None of the bird species were observed to display a clear preference for one seed cake type or the other as depicted in FIG. 2. It should be appreciated that in this first phase, bird and squirrel activity was generally low, due at least in part to seed presentation and substantial variation between locations in prior feeding effort.

FIG. 2 provides a statistical comparison of squirrel and bird feeding events related to the experimental (citrus-scented) seed cakes versus the control (unscented) seed cakes. The mean number of feeding observations is presented as ± standard error. The means are based only on locations where a given bird species was observed during scan sampling events. FIG. 2 further identifies the number of locations where each species was recorded (out of a possible 20 locations), the results of the sign tests, and interpretation of the results.

In the second phase of the trials, the goal was to evaluate whether birds and squirrels express a preference for loose birdseed as compared to seed cakes. This phase of the trials was conducted with birdseed and seed cakes that were not treated with the citrus-scented compound.

The seed cakes utilized in this second phase of the trials were prepared and presented as described above with respect to the first phase. Both the seed cakes and the loose birdseed were prepared with Kaytee Birder's Blend wild birdseed. However, again, it should be appreciated that these seed cakes and loose birdseed mixtures may include other types of seeds without departing from the objects of the present disclosure. The loose birdseed was presented in a wire mesh feeder (having dimensions of approximately 30 cm high, 6 cm in diameter, with 0.5 cm square wire mesh).

Each location selected for the second phase of the trials was observed to have high bird and squirrel activity. The observations for this second phase were made over a two-week period in May 2010.

Bird and squirrel activity was monitored using a Reconyx game camera (model PC85) set to photograph the feeding locations every minute between 5 am and 8 pm. The camera was fixed to a tree, post, or another immobile object approximately 5 feet away from the feeding location. All photos were later reviewed, and bird and squirrel foraging events were quantified. Use of a camera, such as the Reconyx game camera, is more preferable to use of human observers because data collection is instantaneous while human observers typically require at least a few seconds to identify each of the birds or squirrels that may be present at the feeding location. Further, use of a camera typically permits quantification of all squirrel and bird activity at the feeding location during all daylight hours. These instantaneous snapshots of squirrel and bird activity at the feeding location may each be treated as an instantaneous scan sample, as described above with respect to the first phase of the trials.

Sign tests were used to evaluate preference for loose birdseed versus seed cakes. This relative preference for loose birdseed versus seed cakes was calculated using the following formula: the average of [by location: (# of animals observed on the loose birdseed/# of animals observed on seedcakes)]. It should be appreciated that there were some locations where no animals (birds or squirrels) were observed feeding on the seed cakes. Accordingly, these locations were excluded from the average, and the relative preference is presented as being greater than the average that is given.

Each species was examined independently. Eastern Gray squirrels as well as ten bird species were identified during this second phase of the trials. Again, any species observed at fewer than five locations were excluded from the analysis. These species included: Northern Cardinals, Red-bellied Woodpeckers, Downy Woodpeckers, Blue Jays, Common Grackles, House Finches, and Red-winged Blackbirds. However, it should be appreciated that each of these species were only observed feeding on the loose birdseed during the scan sampling trials at each location where present.

FIG. 3 depicts a statistical comparison of squirrel and bird activity at seed cakes versus loose birdseed. The mean number of feeding observations is presented as ± standard error. The means are based only on locations where a given species was observed during scan sampling events. Eight possible locations were available to record species in this phase of the trials. The results of sign tests and relative preferences expressed during this second phase of the trials also are set forth in FIG. 3.

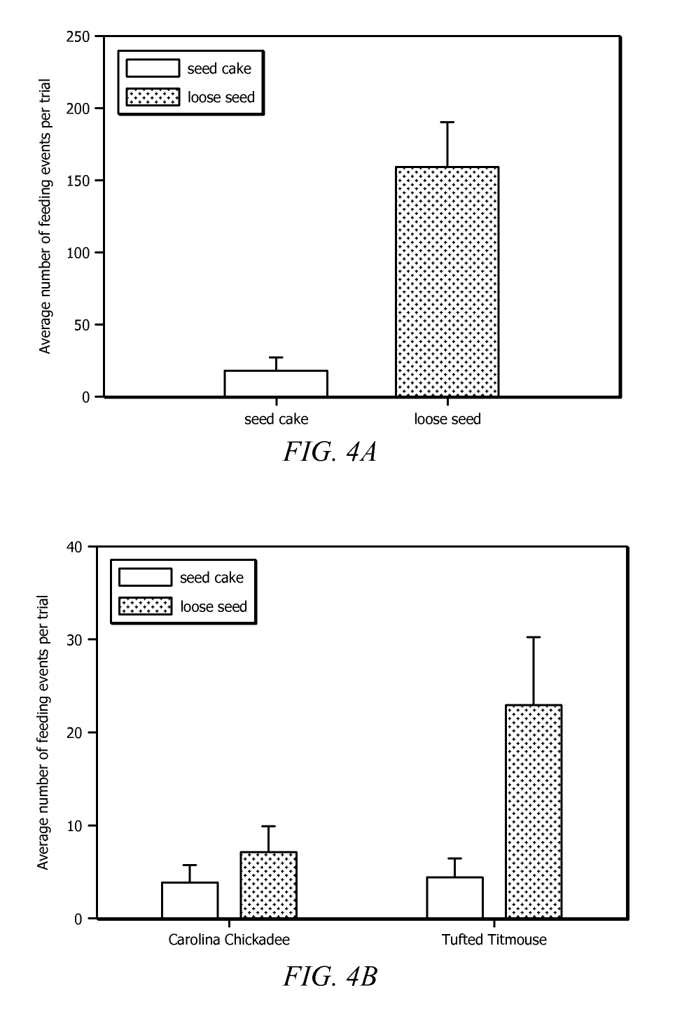

As depicted in FIG. 4, both squirrels and birds expressed a general preference for loose birdseed as opposed to seed cakes. Tufted Titmice and squirrels displayed a preference for loose birdseed over seed cakes as depicted in FIGS. 3 and 4. The activity of Tufted Titmice was approximately eight times higher with respect to loose birdseed as compared to seed cakes, and the activity of the Eastern Gray Squirrels was approximately twenty-seven times higher on loose birdseed as compared to seed cakes. As depicted in FIG. 3, Carolina Chickadees displayed no preference for loose birdseed or seed cakes. It may be inferred from these results that consumers offering seed cakes to their backyard birds are likely to have lower squirrel activity than when using loose birdseed; however, it should be appreciated that bird activity when seed cakes are utilized also may be lower on a relative scale as birds generally express a preference for loose birdseed.

In the final/third phase of the trials, the effectiveness of the citrus-scented compound when applied to loose birdseed was examined. This evaluation of squirrel and bird preference for citrus-scented versus unscented loose birdseed was conducted over approximately a three-month period in Summer 2010.

In this third phase, bird feeders had not been hung at any of the observation locations for at least one year. This experimental design factor served to negate the effect of any prior feeding efforts on the trials.

Fifty locations were selected for this phase of the trials based on the presence of edge habitat and hardwood trees. These locations included backyards as well as the edges of forested lots. The feeders utilized in this phase of the trials were similar to those that were used in the second phase. Feeders were hung on Sheppard hooks with a board affixed to a vertical post, as described above with respect to phase one of the trials. Feeders were hung approximately 4 feet from the ground at each observation location.

The citrus-scented compound according to embodiments of the present disclosure was added to the loose birdseed in a concentration similar to that described above with respect the experimental seed cakes utilized in the first phase of the trial. After mixing, the loose birdseed containing the citrus-scented compound was dried overnight in a forced convection oven at 60° Celsius.

The evaluation of preference for citrus-scented versus unscented loose birdseed did not commence until the presence of squirrel activity for the location was confirmed. Upon confirmation of squirrel activity, the citrus-scented and unscented loose birdseed samples were presented side-by-side in the observation location for a period of three days. During the fourth and fifth days of the evaluation period, the citrus-scented and control (unscented) loose birdseed samples were presented sequentially, with the order of presentation determined by coin toss in a manner similar to that described in above in the first phase of the trials.

Squirrel and bird activity at the various observation locations was again determined by instantaneous scan sampling using a Reconyx camera (HyperFire PC800) programmed to take photos every minute between 5 am and 8 pm daily during the sampling period. Squirrel and bird feeding activity was later evaluated using these photographs.

Sign tests were utilized to evaluate preference for the citrus-scented as opposed to control (unscented) loose birdseed. As in the second phase, each species of bird or squirrel was examined independently. The difference in feeding activity was calculated using the following formula: 1—the average of [for each location: (# of citrus-scented feeding observations/# of control/unscented feeding observations)]. These resulting values may preferably be used to evaluate the expected reduction in squirrel activity if a consumer offers the citrus-scented loose birdseed to their backyard birds rather than unscented loose birdseed.

Eastern Gray squirrels, Eastern Chipmunks, and 12 different bird species were identified during the third phase of the trials. Eastern Chipmunks, Common Grackles, Brown-headed Nuthatches, White-breasted Nuthatches, Brow-headed Cowbirds, Red-headed Woodpeckers, Downy Woodpeckers, and Blue Jays were excluded from the preference evaluation as they were observed at fewer than five observation locations.

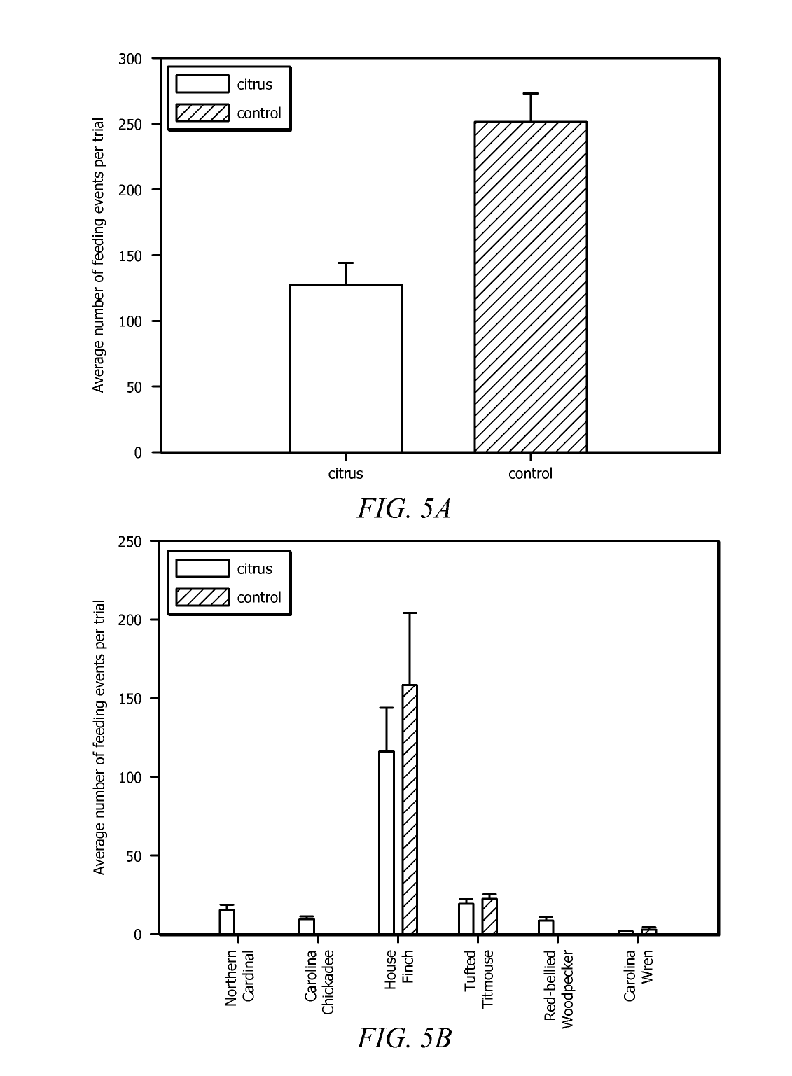

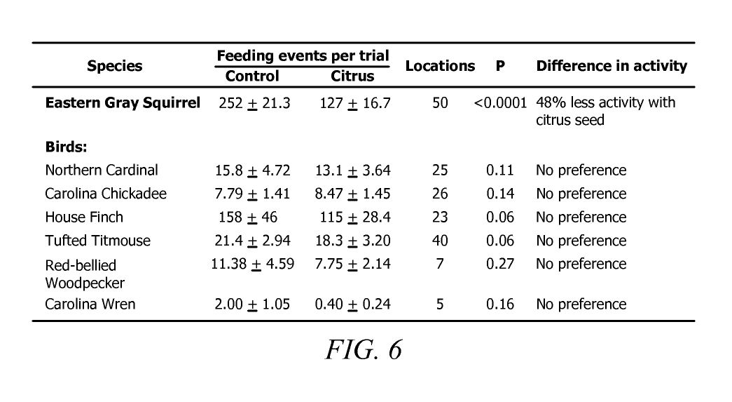

Overall, feeding activity was greater with respect to the control (unscented) loose birdseed than the citrus-scented loose birdseed as depicted in FIG. 5. Eastern Gray squirrels displayed a clear preference for unscented loose birdseed over citrus-scented loose birdseed. In 45 out of 50 locations, squirrel-feeding activity was greater with respect to the unscented loose birdseed as opposed to the citrus-scented loose birdseed as depicted in FIG. 6. Northern Cardinals, Carolina Chickadees, House Finches, Tufted Titmice, Red-bellied Woodpeckers, and Carolina Wrens displayed no preference for citrus-scented loose birdseed over unscented loose birdseed as depicted in FIG. 6.

FIG. 6 provides a statistical comparison of squirrel and bird activity at citrus-scented loose birdseed versus unscented loose birdseed. The mean number of feeding observations is presented as ± standard error.

Means are based only on locations where a given species was observed during scan sampling events. The number of locations where each species was recorded is provided (out of 50 possible locations). In addition, FIG. 6 also includes the results of the sign tests and difference in feeding activity.

An evaluation of the trials indicates that squirrel activity is lower when citrus-scented loose birdseed or seed cakes are utilized as compared to unscented loose birdseed and seed cakes. More specifically, on average, squirrel activity was shown to be 48% lower with respect to citrus-scented loose birdseed or seed cakes than unscented loose birdseed or seed cakes.

A citrus oil concentration of 85 grams of citrus oil for every 1 kilogram of birdseed generally resulted in lower squirrel activity while maintaining high bird activity. Lower concentrations of citrus-scented compound in the loose birdseed or seed cake did not deter squirrels while high concentrations of citrus-scented compound deterred both birds and squirrels. Accordingly, when an optimized amount of citrus-scented compound is added to loose birdseed or seed cakes according to embodiments of the present disclosure, there will be a reduction in squirrel activity surrounding the loose birdseed or seed cakes without any appreciable difference (or necessary reduction) in bird activity. It should be appreciated that even a concentration of 2-5% citrus-scented compound relative to the weight of loose birdseed generally results in lower squirrel activity while maintaining high bird activity.

Another set of trials evaluating citrus-scented birdseed as compared to control (unscented) birdseed was conducted in Bay Beach, Wis. This set of trials involved 130 hours of observations over 11 average days of consumer feeding. Four tests were conducted in this set of trials.

The first and third tests involved a side-by-side comparison of control (unscented) birdseed to citrus-scented birdseed. The citrus-scented compound according to embodiments of the present disclosure was added to loose birdseed in a concentration similar to that described above with respect to the Alabama trials.

In the first test, 46 red squirrels visited the control (unscented) birdseed while only 31 red squirrels visited the citrus-scented birdseed. 582 gray squirrels visited the control birdseed while only 192 gray squirrels visited the citrus-scented birdseed. Overall, more of the control birdseed was consumed than the citrus-scented birdseed (2,267.9 g versus 1,143.1 g) in the first test. The control birdseed attracted approximately 74% of all squirrels in the first test, and squirrels consumed approximately 70% of the food in the first test.

In the third test, no red squirrels visited either the control birdseed or the citrus-scented birdseed. 74 gray squirrels visited the control birdseed versus only 40 who visited the citrus-scented birdseed. Again, more of the control birdseed was consumed than the citrus-scented birdseed (3,265.8 g versus 2,286.8 g) in the third test. The control birdseed attracted approximately 65% of all squirrels in the third test, and squirrels consumed approximately 68% of the birdseed during this test.

The second and fourth tests individually tested the control (unscented) birdseed and the citrus-scented birdseed. In the second test, 14 red squirrels and 397 gray squirrels visited the control birdseed. On the other hand, 17 red squirrels visited the citrus-scented birdseed and only 199 gray squirrels visited the citrus-scented birdseed. Overall, more of the control birdseed was consumed than the citrus-scented birdseed (1,151.1 g versus 888.9 g). Further, more birds visited the citrus-scented birdseed than the control birdseed (295 birds versus 147 birds) in the second test. The control birdseed attracted approximately 66% of all squirrels in the second test, and squirrels consumed approximately 69% of the food. In the fourth test, no red squirrels visited either the control or the citrus-scented birdseed. 75 gray squirrels visited the control birdseed as opposed to only 41 who visited the citrus-scented birdseed. Again, more of the control birdseed was consumed than the citrus-scented birdseed (2,585.2 g versus 1,120.3 g). The control birdseed attracted approximately 65% of all squirrels in the fourth test, and squirrels consumed approximately 71% of the food.

Overall, across the four tests in the Wisconsin trial, the control (unscented) birdseed attracted approximately 70% of all squirrels. On average, squirrels consumed approximately 71% of all food consumed during the tests. Accordingly, squirrel activity is lower when scented loose birdseed or seed cakes are utilized as compared to unscented loose birdseed or seed cakes.

Similar reductions in squirrel activity may be observed when peppermint-scented birdseed mixtures are used in place of citrus-scented birdseed mixtures according to embodiments of the present disclosure. In order to evaluate the effectiveness of peppermint-scented birdseed to deter squirrels according to embodiments of the present disclosure, various trials were conducted at the Bay Beach Wildlife Sanctuary in Green Bay, Wis. in August 2011. A peppermint-scented compound (comprising approximately 1.5% of the total weight of the birdseed) was applied to two types of birdseed, a proprietary blend as well as Kaytee Basic Wildbird.

The proprietary blended peppermint-scented birdseed was compared in a side-by-side test to control (unscented) birdseed (prepared in a similar manner and having a similar composition as previously described with respect to the citrus-scented birdseed trials). Squirrels visited the control birdseed for approximately 581 minutes while squirrels visited the peppermint-scented birdseed for only approximately 203 minutes. Accordingly, squirrels visited the peppermint-scented birdseed 25% of the total time. Further, squirrels made 248 visits to the control birdseed while squirrels only visited the peppermint-scented birdseed 110 times. Accordingly, squirrels only visited the peppermint-scented birdseed in approximately 31% of the total visits.

The Kaytee Basic Wildbird peppermint-scented birdseed was also compared in a side-by-side test to control (unscented) birdseed (also prepared in a similar manner and having a similar composition as previously described with respect to the citrus-scented birdseed trials). Squirrels visited the control birdseed for approximately 481 minutes while squirrels visited the peppermint-scented birdseed for only approximately 53 minutes. Accordingly, squirrels visited the peppermint-scented birdseed approximately 11% of the total time. Further, squirrels made 156 visits to the control birdseed while squirrels only visited the peppermint-scented birdseed 30 times. Accordingly, squirrels only visited the peppermint-scented birdseed in approximately 16% of the total visits.

From these trials, it may be concluded that squirrels tend to prefer the control (unscented) birdseed over peppermint-scented birdseed, regardless the composition of the birdseed to which the peppermint oil is applied. Squirrels tend to spend more time at the control birdseed and make significantly more visits to the control birdseed in contrast to the peppermint-scented birdseed. Thus, squirrel activity is lower when scented loose birdseed or seed cakes are utilized as compared to unscented loose birdseed or seed cakes.

It should be appreciated that the citrus or peppermint scent associated with scented loose birdseed or seed cakes according to embodiments of the present disclosure may diminish in intensity over time. Further, the scented compound may have a tendency to rinse off the loose birdseed, in particular, contained in a feeder, during rain or other storm events. It also should be appreciated that squirrels may become more tolerant to the scented loose birdseed or seed cakes over time, particularly when no alternative loose birdseed or seed cake types (or an alternative food source) is otherwise available for consumption. Nevertheless, the results of these trials provide robust evidence that squirrels are less attracted to scented loose birdseed or seed cakes than unscented loose birdseed or seed cakes.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A birdseed mixture including a scented compound, wherein the scented compound is applied to the birdseed and deters squirrels from feeding on the birdseed.

2. The birdseed mixture of claim 1, wherein the scented compound is citrus-scented.

3. The birdseed mixture of claim 1, wherein the scented compound is peppermint-scented.

4. The birdseed mixture of claim 1, wherein the scented compound coats the birdseed mixture.

5. The birdseed mixture of claim 1, wherein the birdseed mixture is a seed cake.

6. The birdseed mixture of claim 1, wherein the scented compound comprises approximately 1-8% of the birdseed mixture by weight.

7. A method for deterring squirrels from feeding on birdseed, said method comprising:
applying a scented compound to the birdseed.

8. The method of claim 7, wherein the scented compound is citrus-scented.

9. The method of claim 7, wherein the scented compound is peppermint-scented.

10. The method of claim 7, wherein the birdseed is loose birdseed.

11. The method of claim 7, wherein the birdseed is a seed cake.

12. The method of claim 11 wherein the seed cake is formed by the method comprising:
heating water to approximately 150 degrees Fahrenheit;
adding corn sugar dextrose and gelatin to the water to form a first mixture;
adding oil honey, glycerine, propionac liquid/acid and scented oil to the first mixture to form a second mixture; and
blending the second mixture until dispersed.

13. A scented seed cake to deter squirrel consumption, the seed cake comprising:
water, corn sugar dextrose, oil honey, gelatin, glycerine, propionac liquid/acid, and scented oil, wherein the scented oil comprises 1-8% of the seed cake by weight.

14. The scented seed cake of claim 13, wherein the scented oil is peppermint oil.

15. The scented seed cake of claim 13, wherein the scented oil is citrus oil.

16. The scented seed cake of claim 13, wherein the scented oil comprises 1.5% of the seed cake by weight.

17. The scented seed cake of claim 13 further comprising one or more of the following:
cor, cracked corn, striped sunflower seeds, black oil sunflower seeds, safflower seeds, peanuts, peanut hearts, milo, white millet, red millet, nyjer seed, thistle, canary seed, german millet, pepitas, flax seeds, almonds, cherries, and raisins.
